(19) United States
(12) Patent Application Publication
(10) Pub. No.: US 2025/0260281 A1
(43) Pub. Date: Aug. 14, 2025

(54) ROTOR FOR SYNCHRONOUS MOTORS

(71) Applicant: Jacobi Motors, LLC, Webster, TX (US)

(72) Inventors: Ahmed Salah Morsy, Sugar Land, TX (US); Chaitanya Kumar Ravipalli, Richmond, TX (US); Pierre-Olivier Gourmelon, Sugar Land, TX (US); Nathan Rukavina, Pearland, TX (US); Faustino Villarreal-Blozis, League City, TX (US)

(73) Assignee: Jacobi Motors, LLC, Webster, TX (US)

(21) Appl. No.: 18/436,428

(22) Filed: Feb. 8, 2024

(51) Int. Cl. H02K 1/28; H02K 1/278

(52) U.S. Cl. CPC H02K 1/28; H02K 1/278

(57) ABSTRACT

A rotor of a synchronous motor includes a rotor core connected to a shaft, a set of magnets configured to be operably magnetizable and de-magnetizable, and one or more pairs of wedges extending from the rotor core. Each wedge of the one or more pairs of wedges has a proximal end thereof connected to a subset of magnets from the set of magnets. Each wedge of the one or more pairs of wedges is connected by a corresponding rib.

### BACKGROUND

Synchronous electric motors, such as Variable Flux Memory Motors or Wound Field Synchronous Motors, have a wide range of industrial, commercial, and residential applications, such as fans, pumps, compressors, elevators, refrigerators, industrial machinery, and electric motor vehicles because of their high efficiencies. Also, because of using permanent magnets instead of windings in the rotors of the synchronous electric motors, there is less need for rotor cooling. These advantages along with others (e.g., being brushless) make the synchronous electric motors popular where high torque, high efficiency, or low maintenance for electric motors is needed.

Various geometries have been proposed for rotors and stators of synchronous motors to maximize efficiency of converting electric power into rotational motion. Typically, existing geometries of rotors have one or more magnets (such as permanent magnets, soft magnets, or electromagnets) at a circumferential edge of a circular rotor core. The magnetic fields of a stator may interact with magnetic field produced by the magnets to convert electric power to rotational motion.

However, existing geometries are susceptible to producing stray fields and flux leakages. Such stray fields may cause unintentional demagnetization of soft magnets of the rotor. While some proposed geometries use ferrous wedges on either side of the magnets, the shapes and sizes of such wedges do not provide optimal flux linkages for torque generation, particularly when used with materials such as steel. Existing geometries also do not provide flux barriers that better help control magnetization of the magnets, and provide harmonic content thereof. Additionally, existing geometries do not seek to optimize torque ripple content. Existing geometries also position the magnets of the rotor closer to an air gap between the rotor and the stator, thereby making them vulnerable to inefficiencies caused by eddy currents.

Further, existing geometries limit the range of materials used for making the rotor cores, which further limits the degree to which weight and thermal parameters can be optimized. Existing geometries also present limitations in flexibility of manufacturing, assembling, and maintenance of the rotors. Hence, existing solutions/geometries provide a limited set of parameters for optimizing the efficiency of the motors. Existing rotors also provide limited flexibility to modify parameters associated with their geometries.

Therefore, there is a need for a rotor with a geometry that addresses at least the aforementioned inefficiencies of existing solutions. Further, there is a need for a rotor that provides manufacturers with an increased number of parameters for optimizing the efficiency of synchronous motors.

### SUMMARY

In an aspect, embodiments of the present disclosure are directed to a rotor of a synchronous motor. The rotor includes a rotor core connected to a shaft, a set of magnets configured to be operably magnetizable and de-magnetizable, and one or more pairs of wedges extending from the rotor core. Each wedge of the one or more pairs of wedges has a proximal end thereof connected to a subset of magnets from the set of magnets. Each wedge of the one or more pairs of wedges is connected by a corresponding rib.

In another aspect, embodiments of the present disclosure are directed to a Variable Flux Memory Motor (VFMM). The VFMM includes a shaft, a stator, and a rotor connected to the shaft. The rotor includes a rotor core, a set of magnets configured to be operably magnetizable and de-magnetizable, and one or more pairs of wedges extending from the rotor core, each wedge of the one or more pairs of wedges having a proximal end thereof connected to a subset of the set of magnets, and each wedge of the one or more pairs of wedges being connected by a corresponding rib. The rotor is configured to rotate the shaft based on propulsion provided by the stator.

Other aspects of the disclosure will be apparent from the following description and the appended claims.

### BRIEF DESCRIPTION OF THE DRAWINGS

FIG. 1 shows a cross-sectional view of a portion of a rotor known in the art.

FIGS. 2A-2D show cross-sectional views of a portion of a rotor, according to one or more embodiments.

FIG. 3 shows a cross-sectional side view of a Variable Flux Memory Motor (VFMM), according to one or more embodiments.

FIGS. 4A and 4B show distributions of magnetic fluxes in cross-sectional views of a synchronous motor having the rotor, according to one or more embodiments, in comparison to those rotors known in the art.

### DETAILED DESCRIPTION

Specific embodiments of the disclosure will now be described in detail with reference to the accompanying figures. Like elements in the various figures are denoted by like reference numerals for consistency.

In the following detailed description of embodiments of the disclosure, numerous specific details are set forth in order to provide a more thorough understanding of the disclosure. However, it would have been apparent to one of ordinary skill in the art that the disclosure may be practiced without these specific details. In other instances, well-known features have not been described in detail to avoid unnecessarily complicating the description.

As used herein, “about” means approximately or nearly, and in the context of a numerical value or range set forth means±10% of the numeric value.

Throughout the present disclosure, “attachment means” include, but are not be limited to, screws, nails, rivets, adhesives, magnets, hook and loop fasteners, hook and slot fasteners, interlocking elements, friction-grip releasable fasteners, fastening straps, and the like.

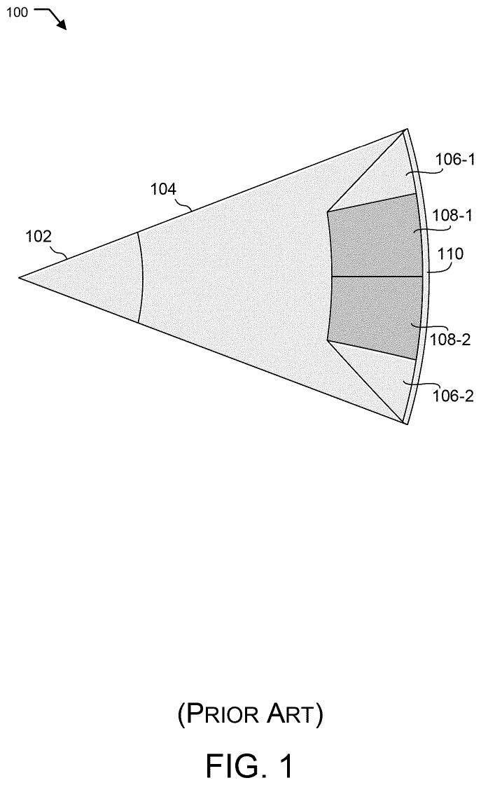

Referring to FIG. 1, a cross-sectional view of a portion of a rotor (100) known in the art is shown. The rotor (100) includes a rotor core (104) connected to a shaft (102). The rotor core (104) may be made of a composite core. The rotor (100) also includes one or more soft rotor magnets (108-1, 108-2) (collectively known as soft rotor magnets (108)), a first ferrous wedge (106-1), and a second ferrous wedge (106-2). The soft rotor magnets (108) are disposed between the first and second ferrous wedges (106-1, 106-2) in a circumferential direction of the rotor core (104). The rotor (100) also includes a sleeve (110) made of carbon fiber wrap configured to keep the soft rotor magnets (108) and the ferrous wedges (106) together.

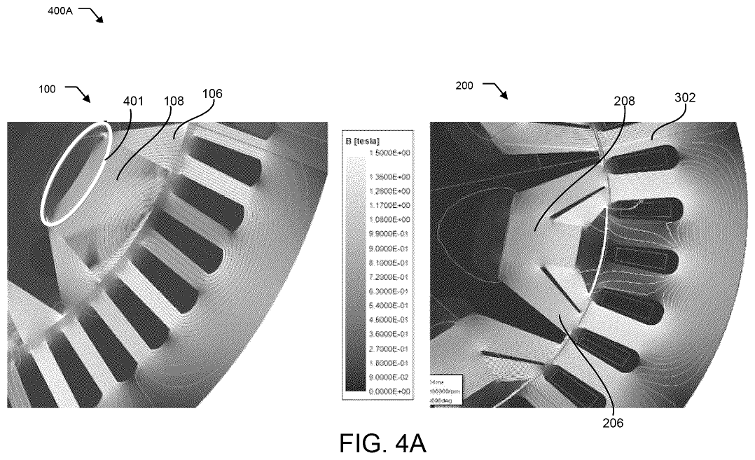

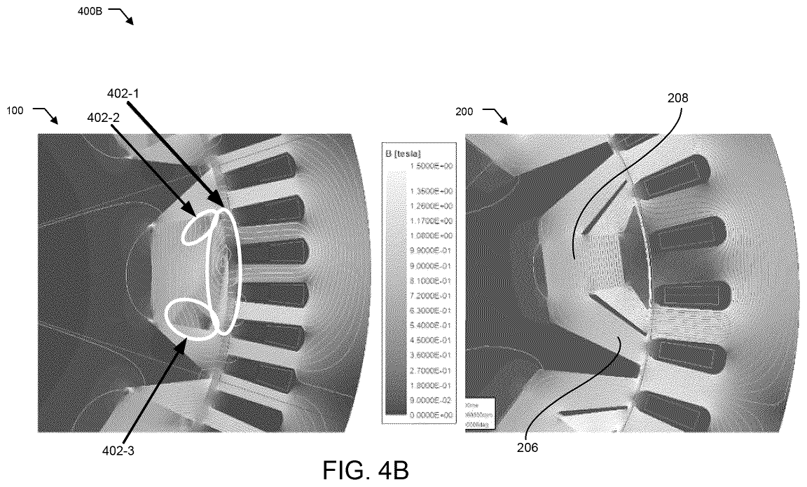

However, such rotors (100) suffer from several disadvantages. The shape of the ferrous wedges (106) may prevent the ferrous wedge (106) from being able to carry enough flux density during a pulse, which may prevent rear portion/back edge of the soft rotor magnets (108) (as shown in FIG. 4A) from being adequately magnetized, thereby causing inefficiencies during its operation. Further, the ratio of pulsing current to nominal current for such rotors (100) may be up to about 4, which may indicate the need for higher pulsing currents for magnetizing the soft rotor magnets (108).

Additionally, since the soft rotor magnets (108) of such rotors (100) are positioned closer to an air gap, which is a gap between the rotor (100) and a corresponding stator, they are susceptible to producing stray magnetic fields, which may cause unintentional (de)magnetization of the soft rotor magnets (108), as shown in FIGS. 4A and 4B. Stray magnetic fields may be carried by the ferrous wedges (106) after a loading/magnetization pulse is passed through the soft rotor magnets (108), and may cause the soft rotor magnets (108) to have an uneven distribution of magnetic flux density.

Hence, the present disclosure provides a geometry for a rotor that addresses at least the aforementioned problems associated with the prior art.

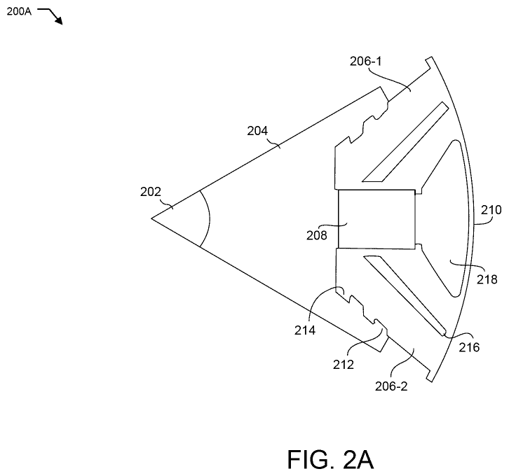

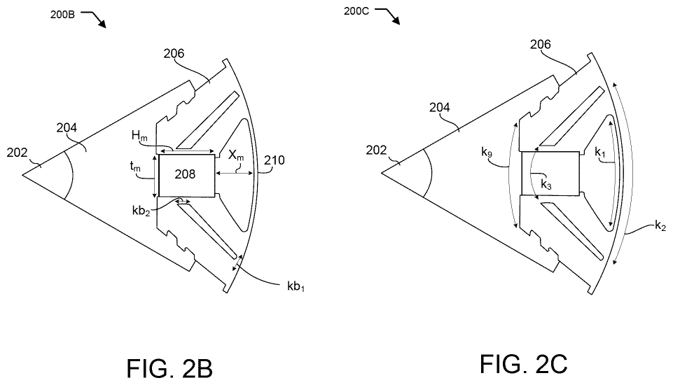

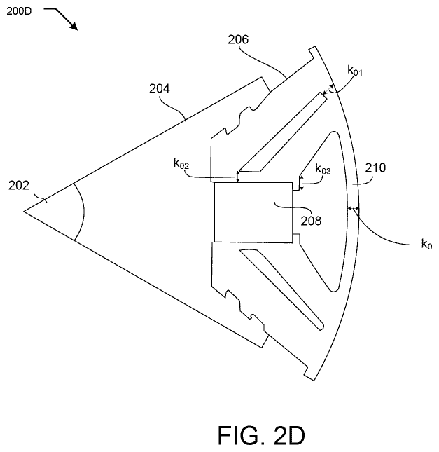

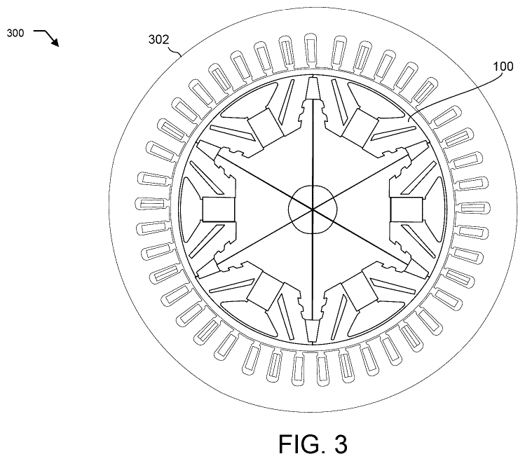

Referring to FIGS. 2A-2D, cross-sectional views of a portion of a rotor (200A, 200B, 200C, 200D) (collectively known as rotor (200)) are illustrated. As shown, the rotor (200) includes a rotor core (204) connected to a shaft (202). The rotor (200) includes a set of magnets (208) attached thereto. The set of magnets (208) may be operably magnetizable and de-magnetizable. The rotor (200) further includes one or more pairs of wedges (206-1, 206-2) (collectively referred to as pairs of wedges (206) or wedges (206)) extending from the rotor core (204), each wedge of the pairs of wedges (206) may have a proximal end thereof connected to a subset of magnets from the set of magnets (208). Further, each wedge of the pairs of wedges (206) may be connected by a corresponding rib (210). In some embodiments, the rotor (200) may be used in a Variable Flux Memory Motor (VFMM) (such as VFMM (300) shown in FIG. 3). While the present disclosure is described in the context of automotive implementations, it may be appreciated by those skilled in the art that the rotor (200) may be suitably adapted for other non-automotive applications as well. Further, while the present disclosure is described in the context of the synchronous motors being VFMM, embodiments of the present disclosure may be suitably adapted for use in other synchronous motors.

In some embodiments, the shaft (202) may be further connected to a load or driven equipment, such as including, but not limited to, wheels of vehicles, pumps, conveyors, fans, compressors, elevators, refrigerators, and the like. The shaft (202) may be configured to transfer rotational force provided by the rotor core (204) to the load. In some embodiments, the shaft (202) may be connected to the rotor core (204) using any one of the attachment means. In some embodiments, the shaft (202) may be integrated into the rotor core (204). In other embodiments, the shaft (202) may be defined to have any geometric profile that maximizes friction/adherence with the rotor core (204). In such embodiments, the shaft (202) may have any of including, but not limited to, a polygonal contour (such as triangular, quadrilateral, pentagonal, hexagonal, etc.), a circular contour, an irregular polygonal contour, a star-shaped contour, and the like. In some embodiments, the rotor core (204) may have an annular gap with a geometric profile corresponding to that of the shaft (202) such that they have an interlocking engagement when assembled.

In some embodiments, the rotor core (204) may be configured to separate the set of magnets (208) from the shaft (202). In such embodiments, separating or distancing the magnets (208) from the shaft (202) provides a stator (such as stator (302) of FIG. 3), with improved leverage to rotate the shaft (202) via the rotor core (204). The dimensions, such as the radius of the rotor core (204), may be suitably adapted based on requirements. In some embodiments, the dimensions of the rotor core (204) may be optimized for minimizing weight, while maximizing efficiency and performance of the rotor (200).

The geometry of the wedges (206) (as described subsequently) may allow the rotor core (204) to be made of a plurality of materials. In some embodiments, the rotor core (204) may be made of aluminum. In other embodiments, the rotor core (204) may be made of composite materials (such as plastics), composite metals, steel, ceramics, or electrical grade steel laminations. The rotor core (204) may be made of metals that are resistant to magnetization. By preventing the rotor core (204) from carrying magnetic fields, the magnets (208) may be allowed to operate without interference or demagnetization due to magnetic fields from the stator (302), thereby improving efficiency of motors implementing the rotor (200) by allowing magnetization states of the magnets (208) to be adjusted with increased accuracy and reliability. Further, the rotor core (204), when made with materials such as aluminum and/or plastics, may reduce weight of the rotor (200), while ensuring adequate structural integrity thereof.

In some embodiments, the rotor core (204) may be an annular structure configured around the shaft (202). In other embodiments, the rotor core (204) may include one or more segmented portions. The segmented portions may be joined together to form the annular structure that may be attachable to the shaft (202) at the annular gap thereof. The segmented portions may be reversibly attached to each other to form the rotor core (204). In some embodiments, the geometric profile of the rotor core (204) may be suitably adapted based on the requirements. In some embodiments, the rotor (200) may be defined to have a smaller diameter in comparison to the rotor (100), or other rotors known in the art, thereby reducing weight and spatial footprint of the rotor (200). In other embodiments, the radius of the rotor (200) may be increased to provide a correspondingly increased leverage for the stator (302).

In some embodiments, the magnets (208) may be mounted between the wedges (206). In some embodiments, the magnets (208) may be mounted using any one or combination of the attachment means. In some examples, the wedges (206) may include one or more interlocking structures that engage with and secure the magnets (208) thereto. In some embodiments, the magnets (208) may be mounted to the wedges (206) such that they are arranged around a circumferential edge of the rotor core (204). In some embodiments, the magnets (208) may be attached to be under compression between the wedges (206). In some embodiments, the magnets (208) may be attached under compression between a set of electrical steel laminations. In some embodiments, the magnets (208) may be configured to be in contact with the rotor core (204). In other embodiments, the magnets (208) may be separated from the rotor core (204).

In some embodiments, the set of magnets (208) may include one or more soft magnets, or one or more hard magnets, or a combination thereof. Embodiments of the present disclosure may have advantages over existing synchronous motors, which use only hard magnets, because hard magnets are made of rare-earth materials and are significantly more expensive than soft magnets. Thus, partially or entirely using soft magnets instead of hard magnets in the synchronous motors significantly reduces manufacturing costs of the synchronous motors of the present disclosure, compared to traditional synchronous motors.

The flux linkage (λₘ) of the soft magnets may be dynamically, and operably, adjustable. In some embodiments, the soft magnets may be implemented in synchronous electric motors. In some examples, the soft magnets may be associated with the VFMMs (300), which may be a type of synchronous motors in which magnetization of the soft magnets may be adjusted (i.e., changed) during operation thereof. The adjustment of the magnetization of the soft magnets (hereinafter, will be referred to as “magnetization” or “magnetization state” for simplicity) may allow the torque and speed output of the motor to be adjustable. According to one or more embodiments, to facilitate the change in the magnetization state of the soft magnets, they may be made of a soft-ferromagnetic material including, but not limited to, aluminum nickel cobalt (AlNiCo), ferrite materials, or some types of ceramics. The soft magnets may be Low Coercive Force (LCF) magnets that produce magnetomotive forces (mmf) when magnetized. Because of the low coercivity of soft magnets, changing their magnetization states require smaller magnetic fields compared to hard-ferromagnetic materials. According to one or more embodiments, the soft magnets may be AlNiCo with grades 1-9 or magnets made of AlNiCo, cast, ceramics, some grades of samarium cobalt, or sintered construction of these materials. It may be apparent to those skilled in the art that specific amounts of these materials may be used to achieve a desired function of the motors implementing the soft magnets. The design, construction, number, and arrangement of the stator, the rotor, and the soft magnets may be suitably adapted based on requirements of the use cases.

In some embodiments, the magnetization states of the soft magnets may be changed to any value from about 0% magnetization (i.e., the soft magnets are completely demagnetized) to about 100% magnetization (i.e., the soft magnets are magnetized to their maximum capacity). The change in the magnetization states may occur in a short time-span, i.e. in about 1 millisecond. In some embodiments, the magnetization states of the soft magnets may be changed by passing a pulse of current therethrough such that the soft magnets are magnetized or de-magnetized up to the desired level. The level of magnetization of the soft magnets may be adjusted by modulating the amplitude of the pulse of current. In some embodiments, the pulse of current may be provided to the soft magnets by a battery or a power source. The pulse of current may cause windings of the stator (302) to produce a magnetic field, which may change the magnetization state of the soft magnets. In some embodiments, the pulse of current from the battery may be modified or channeled through an inverter to controllably adjust the magnetization state of the soft magnets.

Motors with the soft magnets may be a better substitute for conventional synchronous motors due to their ability to be variably magnetized and demagnetized based on requirements. Such motors may provide increased revolutions per minute for a limited voltage supplied thereto. The magnetization states of the soft magnets may also be suitably changed to provide the desired revolutions per minute or power with increased efficiency.

In some embodiments, the soft magnets may be quickly and efficiently magnetized and/or demagnetized during, and after, the soft magnets are assembled inside the motor. Accordingly, such motors may have reduced manufacturing and maintenance costs due to the soft magnets being operably magnetizable or de-magnetizable, during and after assembly by eliminating need for reconfiguration or replacement of the soft magnets if they are found to be of inappropriate magnetization states.

In some embodiments, the wedges (206) may be configured on opposing sides of the magnets (208). Each pair of wedges from the one or more pairs of wedges (206) may be configured to accommodate a subset of magnets from the set of magnets (208) therebetween. In some embodiments, the wedges (206) may be made of magnetic materials. In some embodiments, the magnetic materials may be selected from a group including, but not limited to, ferrous materials, Cobalt, Nickel, magnetic composites, and the like. In such embodiments, the wedges (206) may be made of materials that cause the wedges (206) to be magnetically permeable (at least temporarily) when in presence of a magnetic flux. In some embodiments, the wedges (206) may be defined to magnetize the magnets (208). In such embodiments, the wedges (206) may be configured to direct magnetic flux created by the stator (302) in the air gap towards the magnets (208) for efficient magnetization thereof.

In some embodiments, each wedge (206) may have at least one edge that may be in contact with the magnets (208). In some embodiments, the wedges (206) may be connected to the rotor core (204) using any one or combination of the attachment means. In some embodiments, the pairs of wedges (206) may include one or more grooves (214), and the rotor core (204) may include one or more teeth (212). The grooves (214) and the teeth (212) may be configured to be in an interlocking engagement with each other to attach the wedges (206) to the rotor core (204). In such embodiments, the number of teeth (212) and the grooves (214), and dimensions thereof, may be optimized for providing improved flux path, while minimizing mechanical stress concentration. Further, in such embodiments, the optimized flux paths may be suitable for operation of the rotor (200) at increased speeds. In some embodiments, the wedges (206) may either be in contact or be attached to the corresponding subset of the magnets (208).

In some embodiments, each wedge in the pairs of wedges (206) may be connected by the rib (210). In some embodiments, the rib (210) may be made of magnetic materials. In some embodiments, the pairs of wedges (206) may be integrally connected to each other as a single component. Each pair of wedges (206) and the corresponding rib (210) may be connected to form a single component. In some embodiments, the corresponding rib (210) of each of the wedges (206) may be curved along a circumferential axis thereof. In some embodiments, the rotor (200) may include a sleeve defined on a surface of the rotor (200). In some embodiments, the sleeve may be made of any one or combination of laminated magnetically conductive material or unlaminated magnetically conductive material. In some embodiments, the sleeve may be made of a material having strength greater than a predetermined threshold. The predetermined threshold may correspond to at least one of including, but not limited to, tensile strength, compression strength, shear stress, and the like. In some embodiments, the sleeve may be made of materials that are either, or combination of, magnetically conductive or magnetically resistant. In some embodiments, at least one portion of the sleeve may be made of magnetically conductive materials, and at least one other portion of the sleeve may be made of magnetically resistant materials. In some embodiments, the sleeve may be the rib (210). In other embodiments, the sleeve may be configured around the rib (210).

In some embodiments, each of the wedges (206) may include one or more internal flux barriers (216) that reduce torque ripple and increase reluctance torque of the VFMM (300). The reluctance torque may be increased by optimizing the dimensions of the internal flux barriers (216). In some embodiments, the internal flux barriers (216) may have at least one curved surface. In some embodiments, the number of the internal flux barriers (216) defined on the wedges (206) may be selected based on the reluctance torque required, and positions and dimensions of the magnets (208) with respect to the rotor core (204).

In some embodiments, the wedges (206) may be attached to the rotor core (204) to radially extend outwards therefrom. In some embodiments, the one or more pairs of wedges (206) may be configured to radially extend from each segmented portion in the one or more segmented portions of the rotor (200). In such embodiments, the pairs of wedges (206) may be configured to separate the segmented portions from an air gap of the VFMM (300) by an air gap distance value. The air gap distance value may be determined based on the radius of the rotor (200) and dimensions of the corresponding stator (302). In some embodiments, the air gap may be a gap or distance between the rotor (200), or the wedges (206) thereof, and the stator, such as stator (302) shown in FIG. 3.

In some embodiments, the pairs of wedges (206) may radially extend from the rotor core (204) to form a central flux barrier (218) between the subset of magnets and the corresponding rib (210). The central flux barrier (218) may be configured to separate the subset of magnets from the air gap by a distance value to prevent stray magnetic fields from magnetizing or demagnetizing the set of magnets (208). The distance value may be determined, and suitably adapted based on requirements during manufacturing thereof. The dimensions of the central flux barrier (218) may be suitably optimized to improve magnetization of the magnets (208) while ensuring the magnets (208) provide the desired torque/performance.

In some embodiments, the wedges (206) may be defined to taper from the proximal end to a distal end thereof. In some non-limiting examples, the geometric profile of the wedges (206) may be selected such that the internal flux barriers (216) and the central flux barrier (218) have any one or a combination of including, but not limited to, a prismatic shape, a frustum shape, a truncated pyramidal shape, a cylindrical shape, a conical shape, a frustoconical shape, and the like. In other non-limiting examples, cross-sectional contours of the internal flux barriers (216) and the central flux barrier (218) may be any one or a combination of including, but not limited to, a trapezoidal shape, a parallelogram shape, a rhomboidal shape, a quadrilateral shape, and the like. However, it may be appreciated by those skilled in the art that the internal flux barriers (216) and the central flux barrier (218) may be suitably adapted to have any shape or cross-sectional contour based on requirements. In some preferred embodiments, the internal flux barriers (216) and the central flux barrier (218) may be implemented as cavities. In other embodiments, the internal flux barriers (216) and the central flux barrier (218) may be implemented using non-magnetic materials, or materials that are resistant to being magnetized. The central flux barrier (218) and the one or more internal flux barriers (216), by being unaffected by magnetic fields, may direct magnetic flux to be concentrated on desired portions of the magnets (208), thereby improving magnetizability, and flux distribution of the magnets (208) when magnetized. The central flux barrier (218) and the internal flux barriers (216) may allow the flux path to be optimized for improving magnetization of the magnets (208) while increasing the torque output for a given supply of electric power.

In some embodiments, the geometric shape of the wedges (206), which define the central flux barrier (218) and the internal flux barriers (216), may minimize stray fields in the rotor core (204) from unintentionally magnetizing the magnets (208). Further, in some embodiments, the materials used to make the rotor core (204) may prevent it from being saturated when passing pulse currents to adjust the magnetization state of the magnets (208). In such embodiments, the wedges (206) may improve the flux-linkage of the rotor (200), and improve torque generation.

The dimensions and geometric profile of the rotor (200) may be suitably optimized for either maximizing efficiency/performance, or maximizing control/efficiency for (de)magnetization of the magnets (208). Optimizing for efficient magnetization may reduce the risk of stray magnetic fields causing unintentional demagnetization of the magnets (208), provide even distribution of magnetization of the magnets (208), maximizing 2, minimizing amplitude of magnetization pulses required therefor, and the like. Optimizing for performance may increase the torque or speed output power for the electric power supplied thereto. Other optimization objectives may relate to managing the volume or mass of the magnets (208), wedge saturation, mechanical stress and integrity, and the like. The rotor (200) of the present disclosure provides manufacturers with an increased number of parameters for the optimization. By increasing or decreasing the one or more dimensions/parameters (as described in detail below), the rotor (200) may be optimized for either of the objectives. Further, the rotor (200) may be optimized for the desired operating point of the application.

As shown in FIG. 2B, the rotor (200) may include one or more dimensions that are optimizable, viz. magnet height (Hₘ), magnet thickness (tₘ), length dimension of the central flux barrier (218) (Xₘ), and a first width dimension (kb₁) and a second width dimension (kb₂) of the internal flux barriers (216). In some embodiments, the Hₘ and tₘ may be optimized based on the torque requirements, pulse current requirements for magnetization, cost targets, and overall magnet area. Increase in torque requirements may be resolved by increasing the tₘ and Hₘ. However, increasing the tₘ and Hₘ may risk saturation of the rotor core (204) and/or the stator (302), and may unfavorably affect the pulse current to nominal current ratio, which may be avoided or resolved by suitably optimizing the dimensions of the wedges (206). The tₘ and Hₘ may be determined based on the material/composition of the magnets (208). In some embodiments, the tₘ and Hₘ may be determined based on desired stress distribution at high speeds and retention strategy.

In some embodiments, the Xₘ of the central flux barrier (218) may be suitably determined to control the number of stray magnetic fields that can unintentionally demagnetize the magnets (208). Increasing the Xₘ may prevent stray magnetic currents from changing magnetization state (or distribution of magnetization state over an area) of the magnets (208), and thereby reduce the back-emf constant (λ) of the motor. However, increasing the Xₘ may also affect the ability to magnetize the magnets (208), and hence may be optimized based on other dimensions associated with the rotor (200) to minimize unintentional (de)magnetizations due to stray magnetic fields, while allowing for efficient and reliable intentional (de)magnetizations of the magnets (208).

In some embodiments, the width dimensions (kb₁) and (kb₂) of the internal flux barriers (216) may be optimized to reduce the torque ripple and increase the reluctance torque of the motor.

As shown in FIG. 2C, the rotor (200) may include one or more angles that are optimizable, viz. angle between each of the pairs of wedges (206) (k₁), curvature of the rib (210) (k₂), and angle between the internal flux barriers (216) of the pair of wedges (206) (k₃).

In some embodiments, the k₁ may be indicative of the angle between the two wedges of each pair of wedges (206). In some embodiments, increasing the k₁ may increase the distance between the distal ends of the wedges (206). Further, k₁ and the length of the wedges (206) may be suitably selected to control Xₘ, and the area of the central flux barrier (218). Hence, k₁ may be optimized to control/reduce the reluctance torque. In some embodiments, increasing the length of the wedges (206) may reduce the eddy losses in the rotor (200). While lowering the k₁ may also reduce leakage flux, which may be ideal in some embodiments, the area of the central flux barrier (218) may also correspondingly reduce and risk saturation of the wedges (206), thereby making it difficult to reduce the magnetization of the magnets (208).

In some embodiments, k₂ may be indicative of the curvature or length of the rib (210). Optimizing k₂ may allow for compartmentalizing the central flux barrier (218) into two channels in embodiments where a single barrier ferrous wedge is used. Further, optimizing k₂ may provide increased control over torque ripple and the amount of reluctance torque. The k₂ may also be used for controlling harmonic content for the rotor (200).

In some embodiments, the k₃ angle between the internal flux barriers (216) of the pair of wedges (206) may be optimized to ensure magnetization of the back or rear portion of the magnets (208).

Further, length of the pair of wedges (206) at their proximal ends may be given by k₉. Increasing k₉ may improve structural integrity, albeit at the cost of weight. The k₉ may be suitably adapted for maximizing structural integrity, while minimizing weight.

Additionally, as shown in FIG. 2D, the rotor (200) may also be optimized based on thickness of the rib (210) (k₀), distance between distal end of the internal flux barriers (216) and the air gap (k₀₁), and distance between the internal flux barrier (216) and the magnets (208) (k₀₂).

In some embodiments, k₀, k₀₁, and k₀₂ may be optimized for the purposes of improving manufacturing tolerance of the wedges (206). Increasing each of these parameters may improve manufacturability and their capacity to withstand mechanical stress, albeit with increase in weight of the wedge (206), and hence may be suitably optimized. Additionally, length of interlocking elements of the wedge (206) to secure the magnets (208) (k₀₃) may be suitably optimized to ensure secure engagement of the magnets (208) with the wedges (206) (by maximizing friction therebetween), while minimizing weight and spatial footprint.

In some embodiments, the rotor (200) may be implemented in any synchronous motor, such as, without limitation, in the VFMM (300). Referring to FIG. 3, a cross-sectional side view of the VFMM (300) is illustrated. As shown, the VFMM (300) includes a shaft (such as shafts (202)), a stator (302), and a rotor (such as the rotor (200)). The rotor (200), as described in reference to FIGS. 2A to 2D, may include the rotor core (204), the set of magnets (208) attached to the one or more pairs of wedges (206) extending from the rotor core (204).

The rotor (200) may be connected to the shaft (202). In some embodiments, the rotor (200) may be configured to rotate the shaft (202) based on propulsion provided by the stator (302). In some embodiments, the rotor (200) may be configured to rotate, which in turn causes the shaft (202) to rotate. In some embodiments, the stator (302) may include one or more magnets. In some embodiments, the magnets may include electromagnets indicative of windings or coils wound around a core. The magnetic field produced may be controlled by passing different amplitudes of electric current through the coils. When electric power is supplied to the stator (302), the coils of the stator (302) may produce a magnetic field, which may interact with the magnetic fields of the magnets (208) of the rotor (200). In such embodiments, the interaction of the magnetic fields may cause the rotor (200) to rotate with respect to the stator (302). In some embodiments, the stator (302) may be configured to produce the magnetic fields when a multi-phase electric power is supplied thereto. In some embodiments, the electric power supplied to the stator (302) may cause the magnetic field produced therefrom to shift and rotate about the stator (302). In such embodiments, the magnets (208) may be arranged and magnetized, to cause the rotor (200) to rotate synchronously with the shift in magnetic fields produced by the stator (302).

In some embodiments, when the magnets (208) are magnetized, the stator (302) may cause the rotor (200) to rotate, and thereby drive the shaft (202). In embodiments where the magnets (208) are demagnetized, the rotor (200) may remain unaffected by the magnetic fields produced by the stator (302). The amount of magnetization of the magnets (208) may be suitably adapted based on torque and speed requirements. In such embodiments, the magnetization states of the magnets (208) may be suitably shifted to maximize efficiency for power supplied thereto.

Referring to FIGS. 4A and 4B, distributions (400A, 400B) of magnetic fluxes in cross-sectional views of a synchronous motor having the rotor (200) in comparison to the rotors (100) known in the art are shown.

As shown in FIG. 4A, the existing/known rotors (100) may have lower flux density at the back edge or at the rear portion (as indicated by portion (401)) of the magnet (108), in comparison to the rest of the magnet (108). The lower flux density at the rear portion may be caused by the ferrous wedges (106) being incapable of carrying sufficient flux density during a pulse. The rotor (200) of the present disclosure, on the other hand, provides an even flux density distribution throughout the magnet (208).

Further, pulse current to nominal current ratio for the rotor (100) may be about 3 or 4, while the pulse to nominal current ratio for the rotor (200) may be about 1.5. Hence, the corresponding stator of the existing rotor (100) may be more saturated in comparison to the stator (302) of the rotor (200) of the present disclosure. The dimensions of the wedge (206) may be suitably modified based on that of the soft rotor magnets (108) to prevent the excessive saturation of the stator (302).

As shown in FIG. 4B, the soft rotor magnets (108) of the rotor (100) may experience unintentional demagnetization (402-1, 402-2, 402-3) due to occurrences of stray fields, which may be undesirable due to reduction in torque production thereof. In some embodiments, by having the central flux barrier (218) and the one or more internal flux barriers (216), the wedges (206) may prevent the magnet (208) from experiencing unintentional (de)magnetizations due to the stray magnetic fields, thereby allowing the magnets (208) to have even distribution of magnetic flux.

The rotor (200) of the present disclosure solves the problems associated with existing rotors (100). The rotor (200), by providing the central flux barrier (218), may distance the magnets (208) to prevent unintentional (de)magnetizations thereof from stray magnetic fields produced when passing the pulsing current. Further, the geometry of the wedges (206) allows the magnets (208) to be under compression when configured to the rotor (200). The geometry of the wedges (206) may allow for optimized compression of the magnets (208) without affecting the magnetizability thereof. Further, reducing the pulse current to nominal current ratio by optimizing the dimensions of the magnets (208) and the wedges (206) may allow the motor to be practical and scalable. The geometry of the rotor (200) may also provide manufacturers with the flexibility of optimizing a plurality of parameters/dimensions for improving scalability.

While the disclosure has been described with respect to a limited number of embodiments, those skilled in the art, having benefit of this disclosure, will appreciate that other embodiments can be devised which do not depart from the scope of the disclosure as disclosed herein. Accordingly, the scope of the disclosure should be limited only by the attached claims.

1. A rotor of a synchronous motor comprising:
a rotor core;
a set of magnets configured to be operably magnetizable and de-magnetizable; and
at least one pair of wedges coupled with the rotor core, each wedge of the at least one pair of wedges being coupled with:
a subset of the set of magnets; and
a corresponding rib.

2. The rotor of claim 1, wherein the rotor core comprises at least one segment, the at least one pair of wedges radially extending from the at least one segment to at least another one of segment from an air gap of the synchronous motor.

3. The rotor of claim 1, wherein the rotor core comprises at least one magnetic resistant materials.

4. The rotor of claim 3, wherein the at least one magnetic resistant material comprises at least one of aluminum, steel, composite metals, plastics, and ceramics.

5. The rotor of claim 1, wherein the at least one pair of wedges are selected from a group comprising ferrous materials, Cobalt, Nickel, and magnetic composites.

6. The rotor of claim 1, wherein the at least one pair of wedges comprise at least one groove, and the rotor core comprises at least one tooth, the at least one groove and the at least one tooth interlock to operably attach the at least one pair of wedges to the rotor core.

7. The rotor of claim 1, wherein each wedge of the at least one pair of wedges comprises at least one internal flux barrier to operably modify torque ripple and reluctance torque of the synchronous motor.

8. The rotor of claim 7, wherein the at least one internal flux barrier comprises at least one of a prismatic shape, a frustum shape, a truncated pyramidal shape, a cylindrical shape, a conical shape, and a frustoconical shape.

9. The rotor of claim 1, wherein each of the at least one pair of wedges radially extends from the rotor core to form a central flux barrier between the subset of magnets and the corresponding rib.

10. The rotor of claim 1, wherein each wedge in the at least one pair of wedges tapers from a proximal end to a distal end.

11. The rotor of claim 1, wherein the corresponding rib of each of the at least one pair of wedges comprises a curve along a circumferential axis.

12. The rotor of claim 1, wherein the set of magnets is operably under compression between the at least one pair of wedges.

13. The rotor of claim 1, wherein the at least one pair of wedges comprises at least one interlocking structure that operably engage the set of magnets.

14. The rotor of claim 1, wherein the at least one pair of wedges are operably connected to each other.

15. The rotor of claim 1, further comprising a sleeve on a surface of the rotor, the sleeve comprising at least one laminated magnetically conductive material and unlaminated magnetically conductive material.

16. The rotor of claim 1, further comprising a sleeve on a surface of the rotor, at least one portion of the sleeve comprising at least one magnetically conductive material or magnetically resistant material.

17. A Variable Flux Memory Motor (VFMM) comprising:
a stator; and
a rotor connected to a shaft, the rotor comprising:
a rotor core;
a set of magnets configured to be operably magnetizable and de-magnetizable; and
at least pair of wedges extending from the rotor core, each wedge of the at least one pair of wedges being coupled with a subset of the set of magnets and a corresponding rib, wherein the rotor is configured to operably rotate the shaft in response to on the stator.

18. The VFMM as claimed in claim 17, wherein the at least one pair of wedges are coupled with each other.

19. The rotor of claim 9, wherein the central flux barrier is configured to separate the subset of magnets by an air gap in the synchronous motor.

20. The rotor of claim 9, wherein the central flux barrier comprises at least one of a prismatic shape, a frustum shape, a truncated pyramidal shape, a cylindrical shape, a conical shape, and a frustoconical shape.
